(19) United States
(12) Patent Application Publication
(10) Pub. No.: US 2013/0071224 A1
(43) Pub. Date: Mar. 21, 2013

(54) STORAGE DEVICE TESTING SYSTEMS

(71) Applicant: Teradyne, Inc., North Reading, MA (US)

(72) Inventors: Brian S. Merrow, Harvard, MA (US); John P. Toscano, Auburn, MA (US); Tom Dutremble, North Smithfield, RI (US); Eric L. Truebenbach, Sudbury, MA (US)

(73) Assignee: Teradyne, Inc., North Reading, MA (US)

(21) Appl. No.: 13/623,282

(22) Filed: Sep. 20, 2012

Related U.S. Application Data
(60) Provisional application No. 61/537,551, filed on Sep. 21, 2011.

(51) Int. Cl. B65G 1/06; A47B 81/00

(52) U.S. Cl. 414/806; 211/13.1; 414/222.01; 414/222.09

(57) ABSTRACT

A storage device test system includes a test slot configured to receive at least two storage devices for testing, the at least two storage devices being in a same plane.

### CLAIM OF PRIORITY

This application claims priority under 35 U.S.C. §119(e) to provisional U.S. Patent Application No. 61/537,551, filed on Sep. 21, 2011, the entire contents of which are hereby incorporated by reference.

### TECHNICAL FIELD

This disclosure relates to storage device testing systems.

### BACKGROUND

Storage device manufacturers typically test manufactured storage devices for compliance with a collection of requirements. Test equipment and techniques exist for testing large numbers of storage devices serially or in parallel. Manufacturers tend to test large numbers of storage devices simultaneously or in batches. Storage device testing systems typically include one or more tester racks having multiple test slots that receive storage devices for testing. In some cases, the storage devices are placed in carriers which are used for loading and unloading the storage devices to and from the test racks.

### SUMMARY

The techniques described herein can provide one or more of the following advantages. The total floor space of testing facilities can be reduced, and the testing of storage devices can be accomplished asynchronously (e.g., so that each storage device can start and finish its processing steps as soon as possible, without waiting for the loading, unloading, or processing of other storage devices). Similarly, tester resources, such as communication, temperature control, and voltage control, can also be made asynchronous, so that each parameter can be controlled separately for each storage device under test. For mechanical devices, such as hard drive devices (HDDs), vibration management may similarly allow separate clamping, dampening, isolation, and controls for each HDD. Furthermore, storage devices can be identified based on the known identities of other storage devices.

### DESCRIPTION OF DRAWINGS

FIG. 1 is a perspective view of a storage device testing system.

FIG. 2A is perspective view of a test rack.

FIG. 2B is a detailed perspective view of a carrier receptacle from the test rack of FIG. 2A.

FIGS. 3A and 3B are perspective views of a test slot carrier.

FIG. 3C is a perspective view of a storage device tester rack.

FIG. 4 is a perspective view of a test slot assembly.

FIG. 5 is a top view of a storage device testing system.

FIG. 6 is a perspective view of a storage device testing system.

FIGS. 7A and 7B are perspective views of a storage device transporter.

FIG. 8A is a perspective view of a storage device transporter supporting a storage device.

FIG. 8B is a perspective view of a storage device transporter receiving a storage device.

FIG. 8C is a perspective view of a storage device transporter carrying a storage device aligned for insertion into a test slot.

FIG. 9 is a diagram of a manipulator.

FIGS. 10A-10E are diagrams of storage device transporters.

FIG. 11 is a diagram of a storage device transporter and test slot.

FIGS. 12A and 12B are diagrams of storage device transporters.

FIGS. 13A and 13B are diagrams of a storage device transporters and a test slot, respectively.

FIGS. 14A and 14B are diagrams of end effectors.

Like reference symbols in the various drawings indicate like elements.

### DETAILED DESCRIPTION

### System Overview

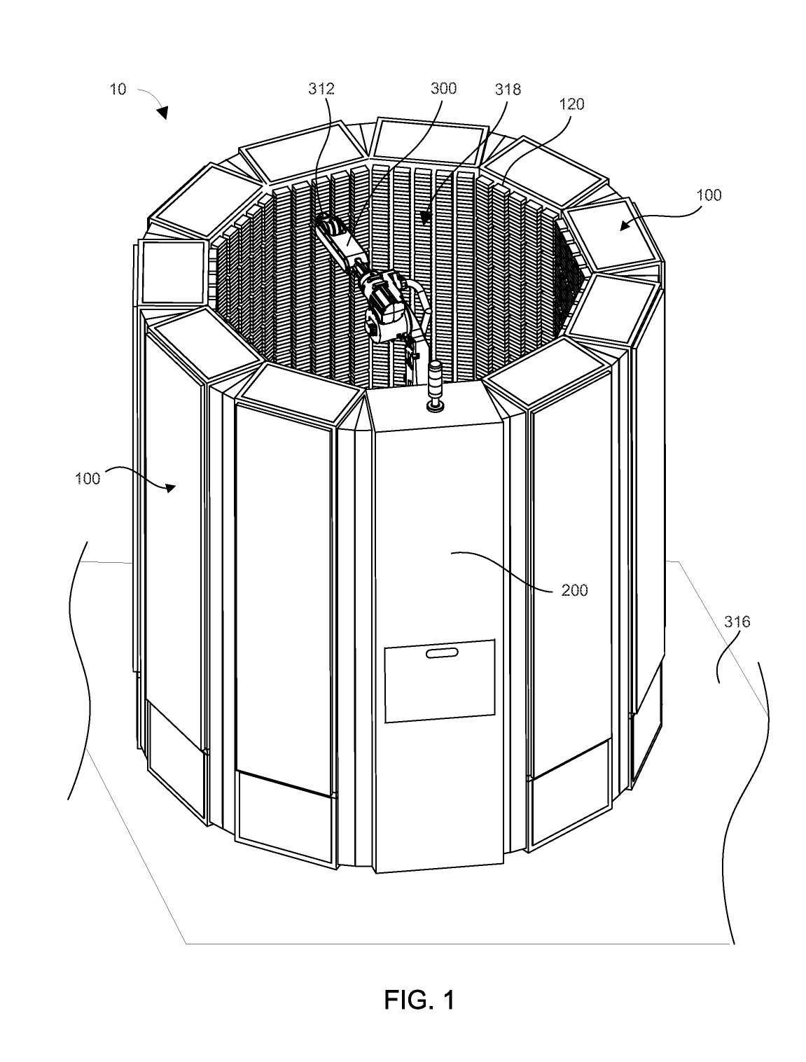

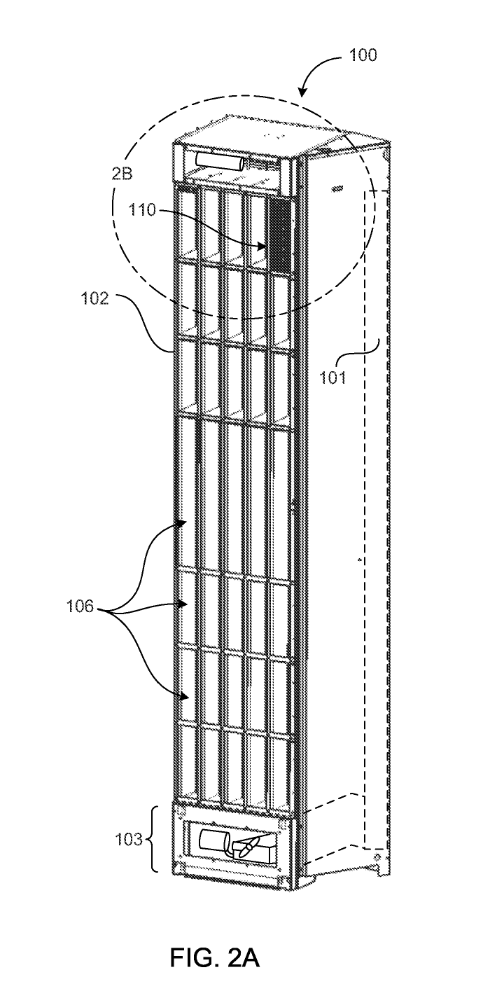

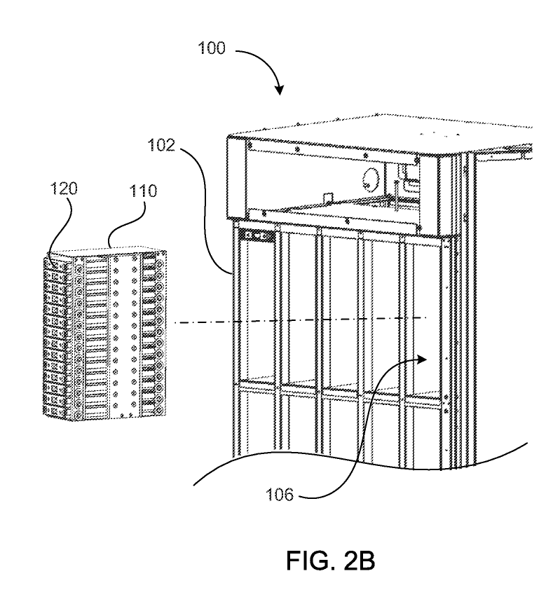

As shown in FIG. 1, a storage device testing system 10 includes a plurality of test racks 100 (e.g., 10 test racks shown), a transfer station 200, and a robot 300. As shown in FIGS. 2A and 2B, each test rack 100 generally includes a chassis 102. The chassis 102 can be constructed from a plurality of structural members 104 (e.g., formed sheet metal, extruded aluminum, steel tubing, and/or composite members) which are fastened together and together define a plurality of carrier receptacles 106. Although the storage device testing system 10 is shown in a circular configuration, the techniques described herein can be used in combination with storage device testing systems of any configuration (e.g., linear arrangements and the like).

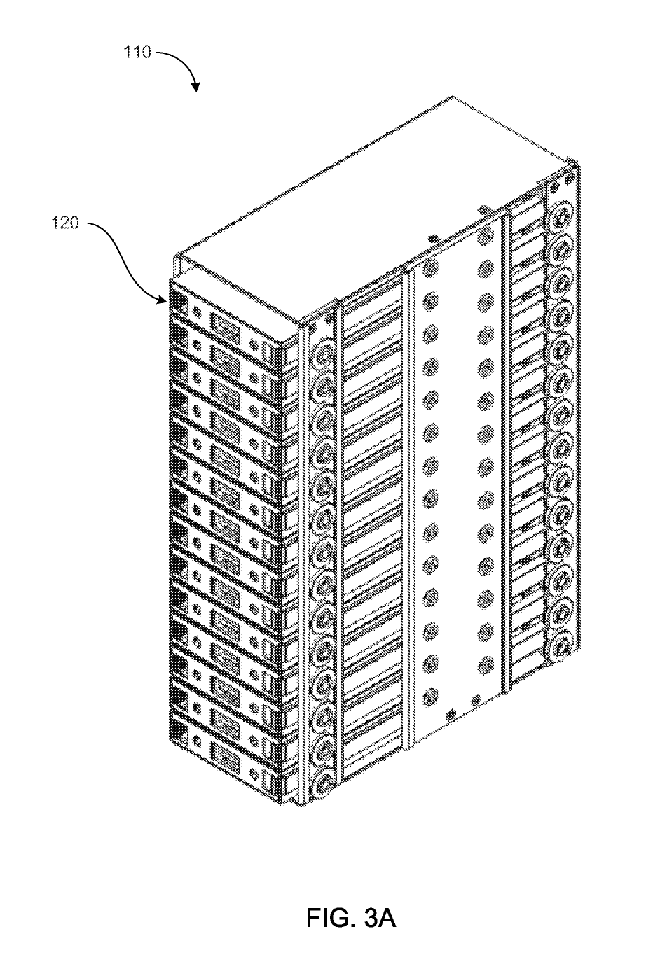

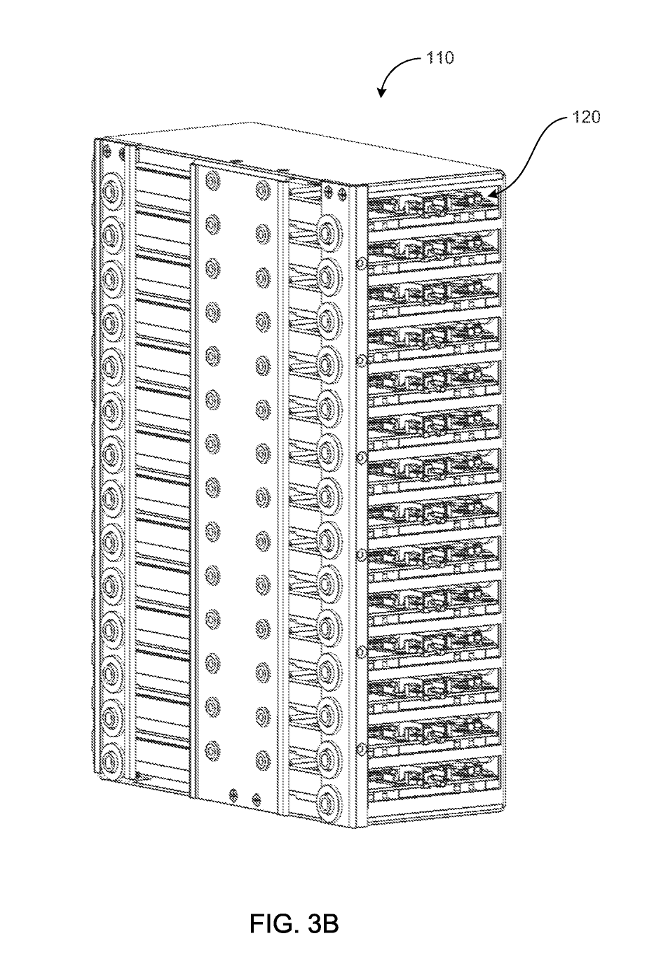

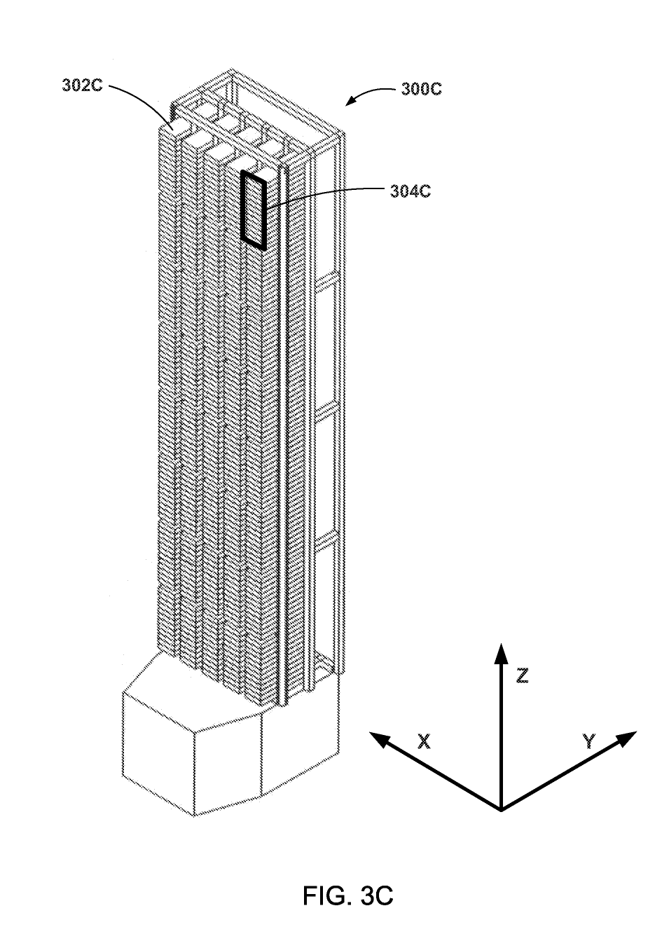

Each carrier receptacle 106 can support a test slot carrier 110. As shown in FIGS. 3A and 3B, each test slot carrier 110 supports a plurality of test slot assemblies 120. Different ones of the test slot carriers 110 can be configured for performing different types of tests and/or for testing different types of storage devices. The test slot carriers 110 are also interchangeable with each other within among the many carrier receptacles 106 within the testing system 10 allowing for adaptation and/or customization of the testing system 10, e.g., based on testing needs. In the example shown in FIG. 2A, an air conduit 101 provides pneumatic communication between each test slot assembly 120 of the respective test rack 100 and an air heat exchanger 103. The air heat exchanger 103 is disposed below the carrier receptacles 106 remote to received test slot carriers 110.

FIG. 3C shows a perspective view of a storage device tester rack 300C, containing multiple storage device test slots 304. Each of the storage device test slots 304 are configured to support a transporter (e.g., a storage device transporter 400 or any of the dual storage device transporters described below). Additional details of the test rack infrastructure and features combinable with those described herein may also be found in the following U.S. patent application Ser. No. 12/698,575, filed on Feb. 2, 2010 and entitled “STORAGE DEVICE TESTING SYSTEM COOLING,” the entire contents of which are incorporated herein by reference.

A storage device, as used herein, includes disk drives, solid state drives, memory devices, and any device that benefits from asynchronous testing. A disk drive is generally anon-volatile storage device which stores digitally encoded data on rapidly rotating platters with magnetic surfaces. A solid-state drive (SSD) is a data storage device that uses solid-state memory to store persistent data. An SSD using SRAM or DRAM (instead of flash memo is often called a RAM-drive. The term solid-state generally distinguishes solid-state electronics from electromechanical devices.

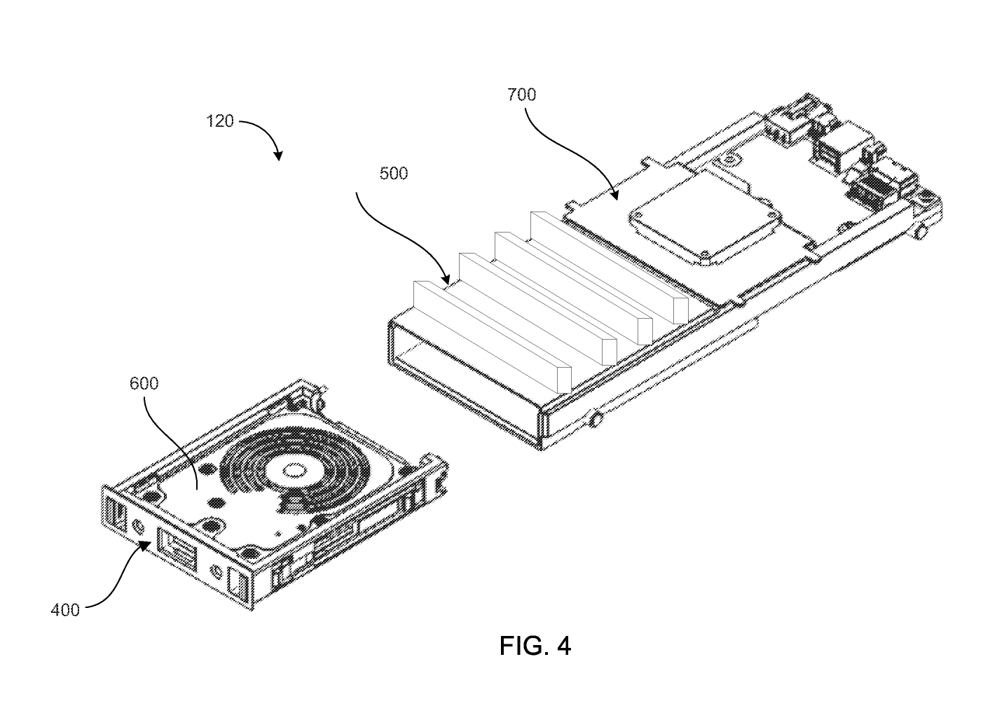

As shown in FIG. 4, each test slot assembly 120 includes a storage device transporter 400, a test slot 500, and an associated air mover assembly 700. The storage device transporter 400 may be used for capturing storage devices 600 (e.g., from the transfer station 200) and for transporting the storage device 600 to one of the test slots 500 for testing.

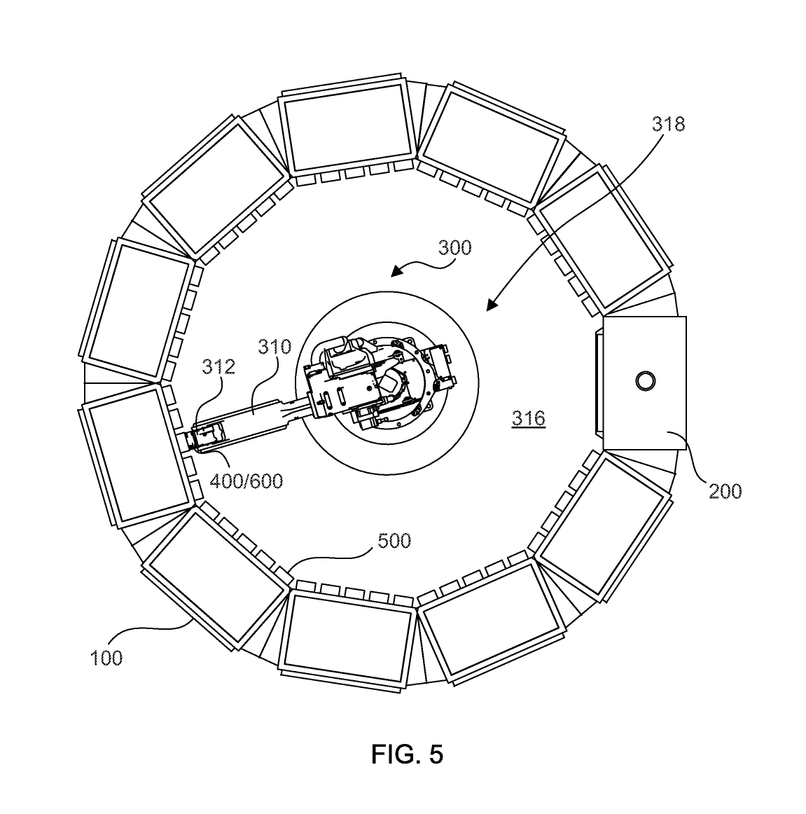

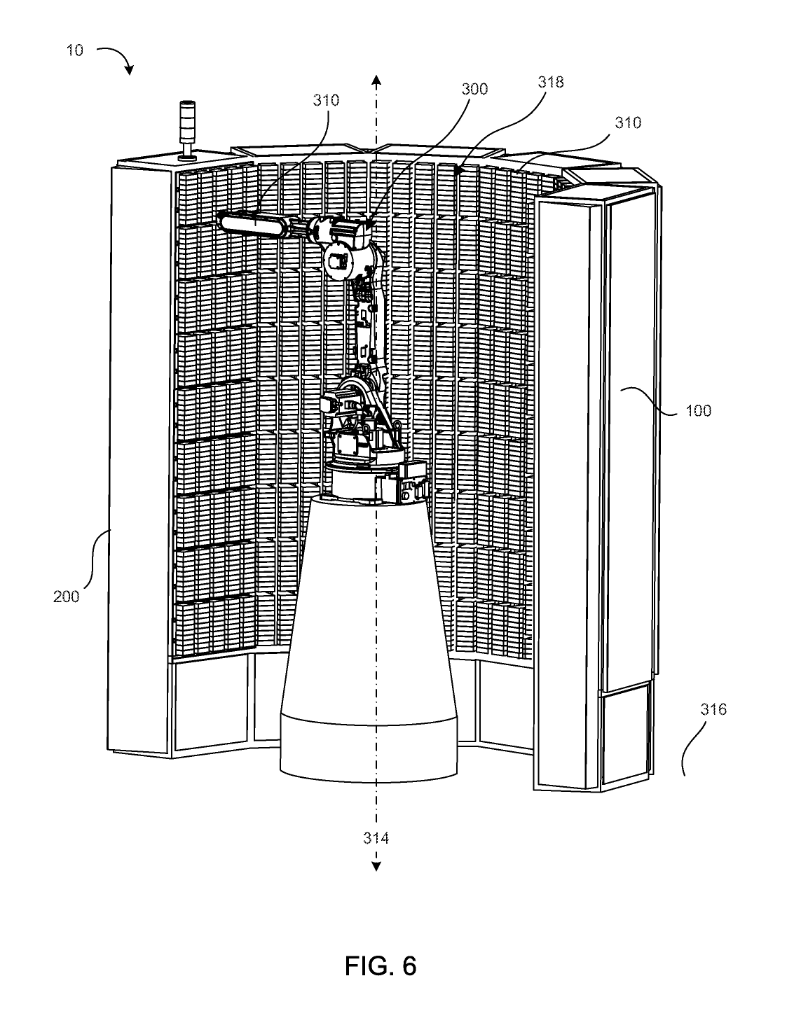

Referring to FIGS. 5 and 6, the robot 300 includes a robotic arm 310 which is an example of an automated transporter than may be used within the system, and a manipulator 312 sometimes referred to as an end effector) disposed at a distal end of the robotic arm 310. The robotic arm 310 defines a first axis 314 (FIG. 6) normal to a floor surface 316 and is operable to rotate through a predetermined arc about and extends radially from the first axis 314 within a robot operating area 318. The robotic arm 310 is configured to independently service each test slot 500 by transferring storage devices 600 between the transfer station 200 and the test racks 100. In some embodiments, the robotic arm 310 is configured to remove a storage device transporter 400 from one of the test slots 500 with the manipulator 312, then pick up a storage device 600 from the transfer station 200 with the storage device transporter 400, and then return the storage device transporter 400, with a storage device 600 therein, to the test slot 500 for testing of the storage device 600. After testing, the robotic arm 310 retrieves the storage device transporter 400, along with the supported storage device 600, from one of the test slots 500 and returns it to the transfer station 200 (or moves it to another one of the test slots 500) by manipulation of the storage device transporter 400 (i.e., with the manipulator 312). In some embodiments, the robotic arm 310 is configured to pick up a storage device 600 from the transfer station 200 with the manipulator 312, then move the storage device 600 to a test slot 500, and deposit the storage device 600 in the test slot 500 by means of depositing the storage device 600 in the storage device transporter 400 and then inserting the storage device transporter in the test slot 500. After testing, the robotic arm 310 uses the manipulator 312 to remove the storage device 600 from the storage device transporter 400 and return it to the transfer station 200.

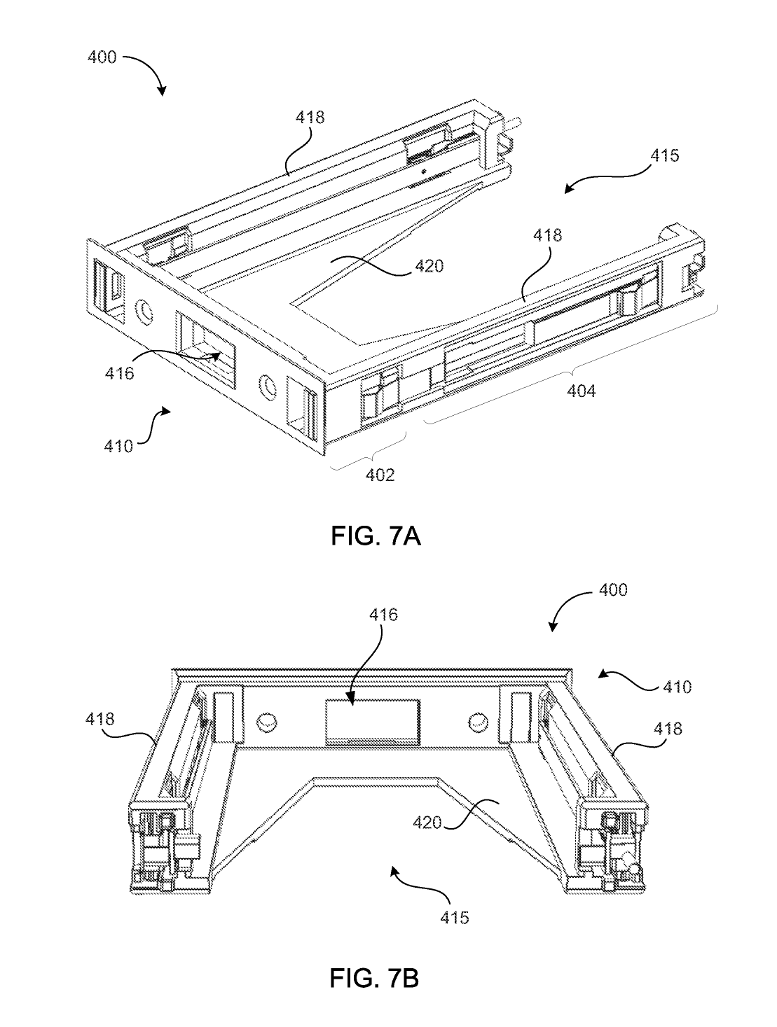

Referring to FIGS. 7A and 7B, the storage device transporter 400 includes a frame 410. The frame 410 includes a face plate 412. As shown in FIG. 7A, along a first surface 414, the face plate 412 defines an indentation 416. The indentation 416 can be releaseably engaged by the manipulator 312 (FIG. 5) of the robotic arm 310, which allows the robotic arm 310 to grab and move the transporter 400. As shown in FIG. 7B, the face plate 412 also includes beveled edges 417. As illustrated in FIGS. 7A and 7B, the storage device transporter 400 includes a transporter body 410 having first and second portions 402, 404. The first portion 402 of the transporter body 410 includes a manipulation feature 416 (e.g., indention, protrusion, aperture, etc.) configured to receive or otherwise be engaged by the manipulator 312 (FIG. 5) for transporting. The second portion 404 of the transporter body 410 is configured to receive a storage device 600. In some examples, the second transporter body portion 404 defines a substantially U-shaped opening 415 formed by first and second sidewalk 418 and a base plate 420 of the transporter body 410. The storage device 600 is received in the U-shaped opening 415.

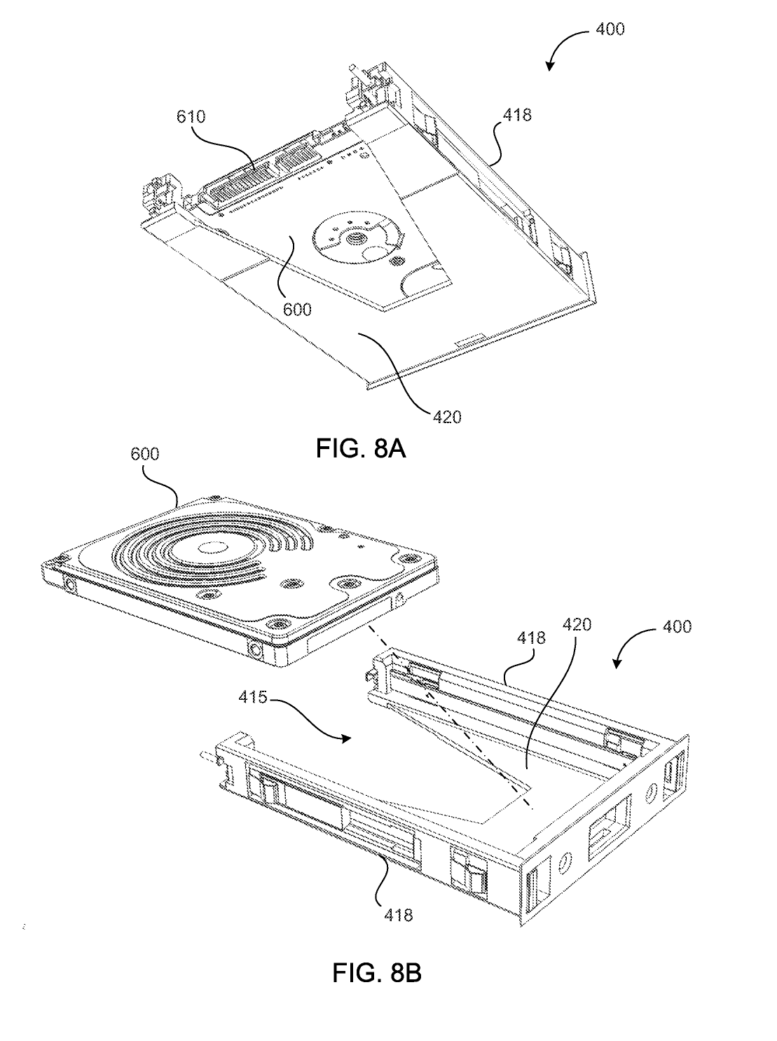

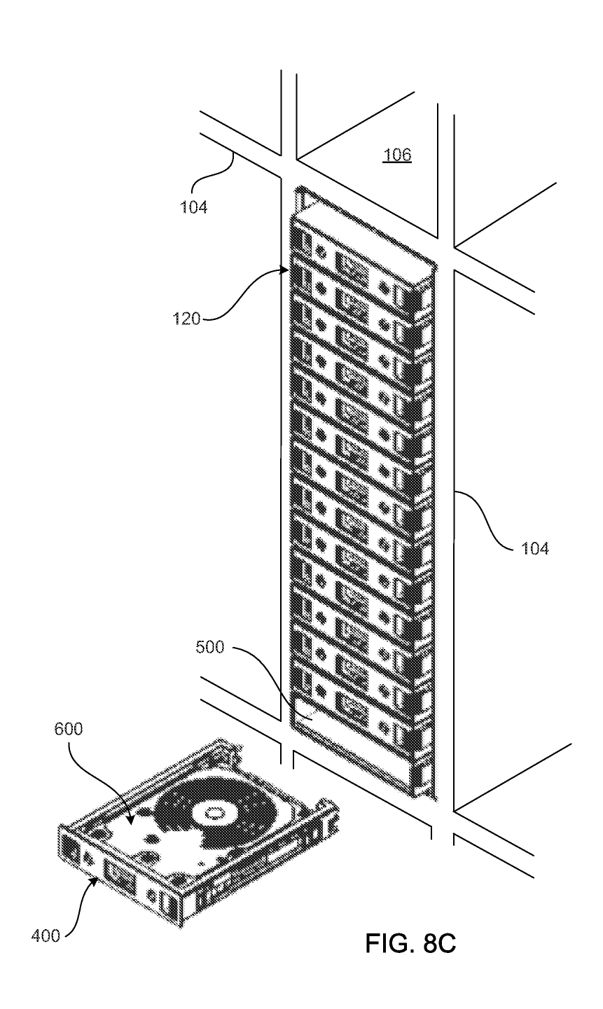

As illustrated in FIGS. 8A and 8B, with the storage device 600 in place within the frame 410 of the storage device transporter 400, the storage device transporter 400 and the storage device 600 together can be moved by the robotic arm 310 (FIG. 6) for placement within one of the test slots 500. A detailed description of the manipulator and other details and features combinable with those described herein may be found in U.S. patent application Ser. No. 12/104,536, filed on Apr. 17, 2008 and entitled “Transferring Disk Drives Within Disk Drive Testing Systems,” the entire contents of which are hereby incorporated by reference.

Dual Storage Device Transporter

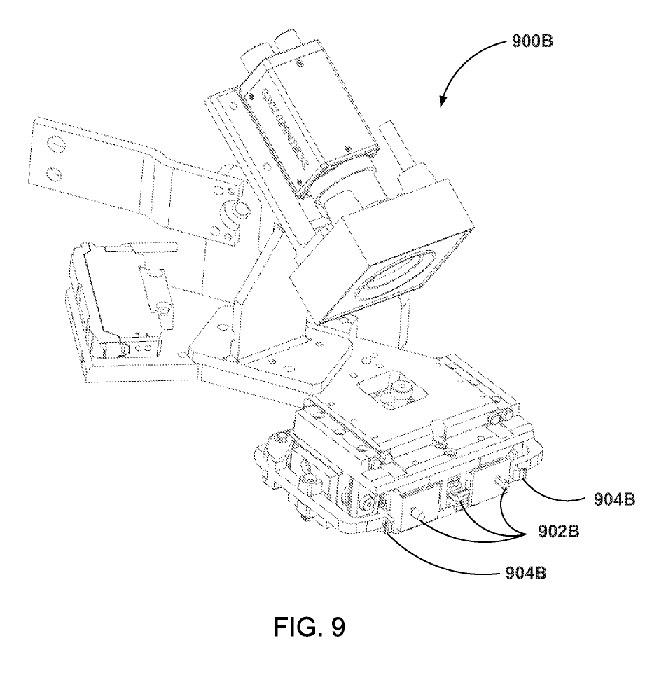

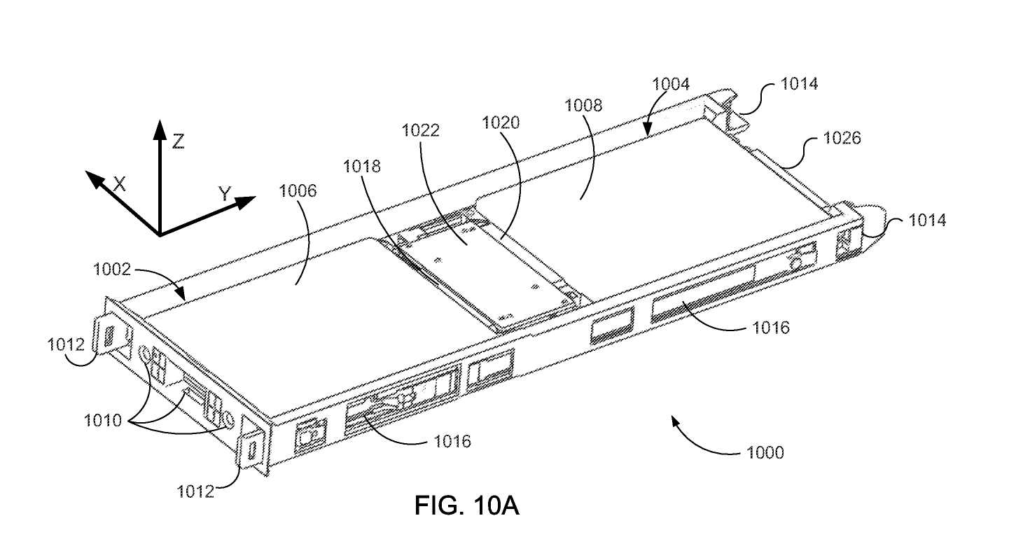

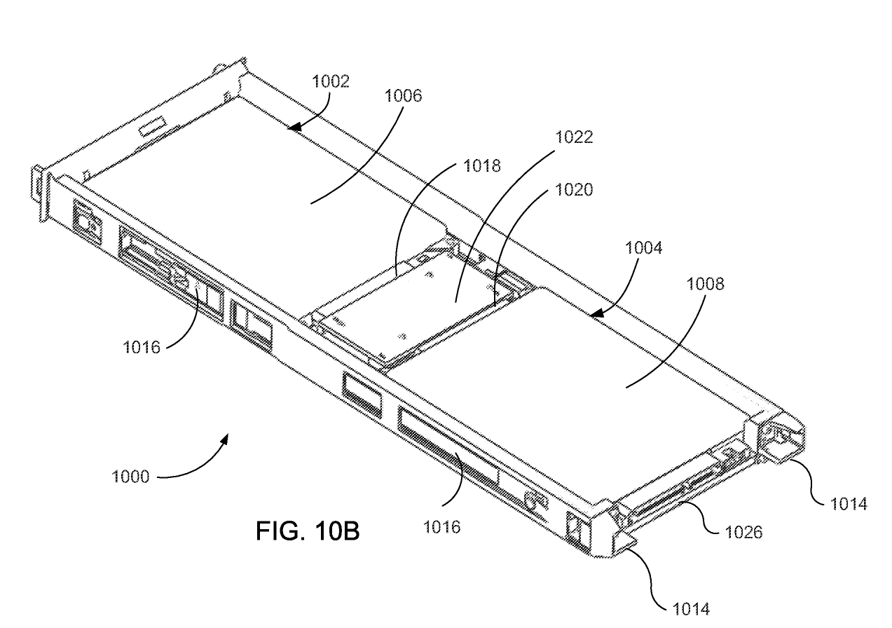

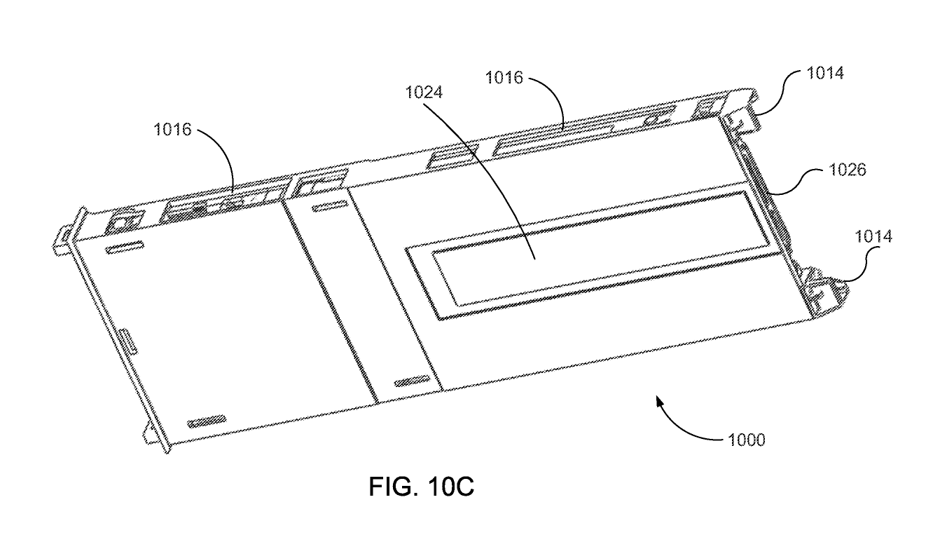

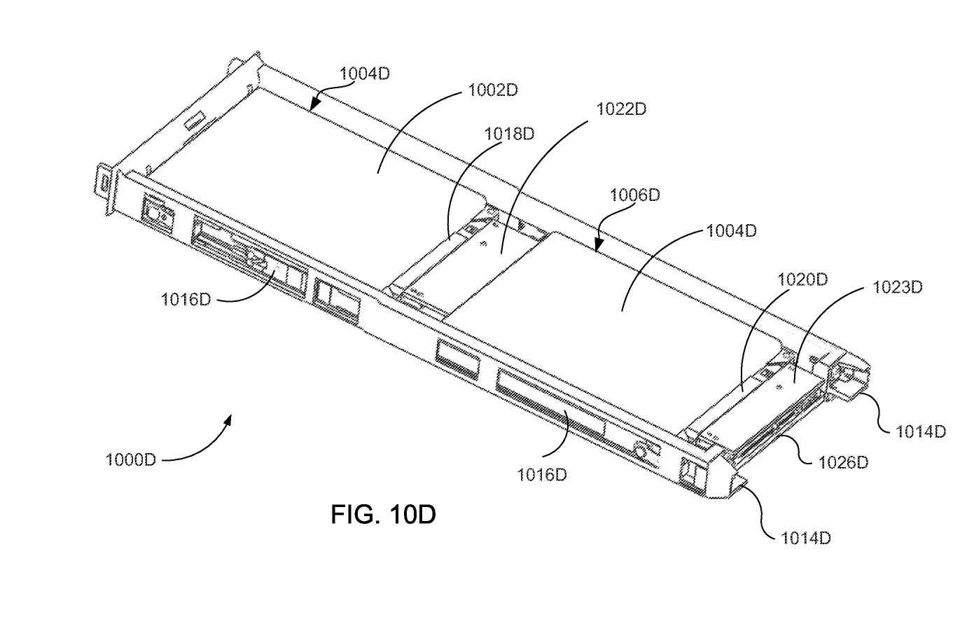

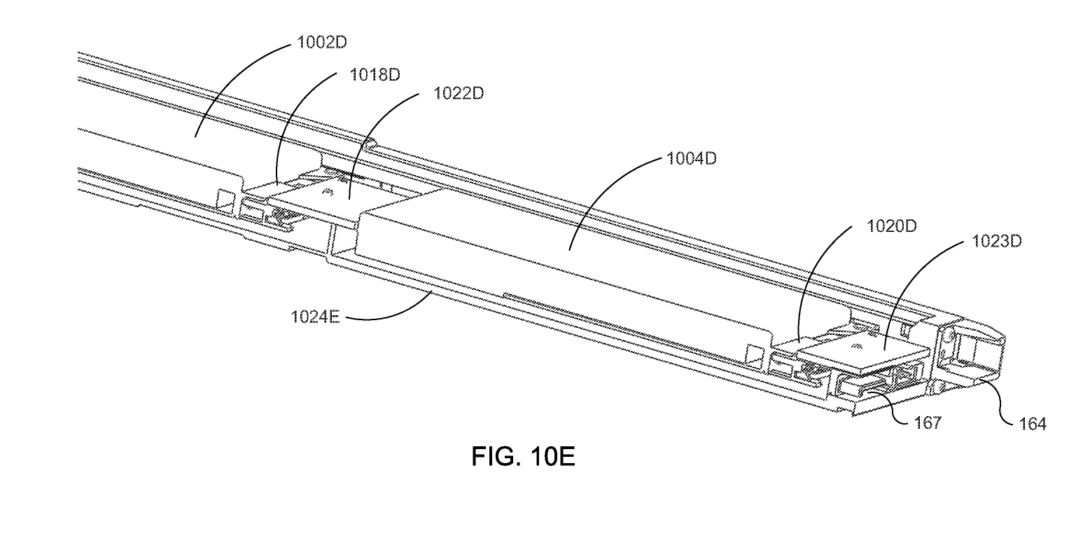

FIGS. 10A and 10B show topside isometric views of a dual storage device transporter 1000 that includes two cavities 1002, 10004 that are each configured to support (e.g., by clamping with one or more engaging elements) a respective storage device 1006, 1008. The dual storage device transporter 1000 includes automation engagement features 1010 which are arranged to engage (e.g., to mate or connect with) corresponding engagement elements 902B on a manipulator 900B (FIG. 9). The dual storage device transporter 1000 also includes clamp actuators 1012, which are arranged to engage to mate or connect with) corresponding clamp engagement elements 904B on the manipulator 900B. A rear portion of the dual storage device transporter 1000 includes electrical connectors 1014, which may be used to connect to electrical elements associated with a test slot (e.g., heating devices and temperature sensors or other sensors). The dual storage device transporter 1000 also includes supportive heating elements 1016 that, when engaged by actuators within a test slot in order to cause the supportive heating elements 1016 to abut against the storage devices 1006, 1008, the supportive heating elements 1016 can support (e.g., clamp) the storage devices 1006, 1008 within the dual storage device transporter 1000 and within the test slot. When power (e.g., electrical current) is supplied to the supportive heating elements 1016, resistive elements associated with the supportive heating elements 1016 can transfer heat directly to a surface of the storage devices 1006, 1008. The heat generated by the supportive heating elements 1016 can be used to provide specific temperature conditions for testing the performance of the storage devices 1006, 1008 (e.g., while the storage devices 1006, 1008 are being tested within a test slot).

The dual storage device transporter 1000 can simultaneously support two storage devices in a tandem arrangement (e.g., arranged along the y-axis, as shown). Because such an arrangement allows multiple storage devices to share resources within a test slot and/or a transporter (e.g., the automation engagement features 1010 and the electrical connectors 1014), the density of a storage device testing system can be reduced. In some examples, it is advantageous for storage device testing systems to be as dense as possible, so as to minimize the total floor space used. Furthermore, in some examples, an asynchronous test environment can allow each storage device to begin and complete its processing steps as soon as possible, without waiting for the loading, unloading, or processing of other storage devices. Similarly, any tester resources, such as communication, temperature control and voltage control, are preferably also asynchronous in nature, so that each parameter can be controlled separately for each storage device under test. For mechanical devices, such as HDDs, vibration management may similarly allow separate clamping, dampening, isolation, and controls for each HDD.

The storage devices 1006, 1008 include respective electrical connectors 1018, 1020 which are plugged into opposing sides of an interposer 1022. The signals provided by each of the connectors 1018, 1020 are carried from the interposer 1022 through a conductive cable or flex circuit 1024 (FIG. 10C) to a common connector 1026 configured to mate with an electrical connector of a test slot. Although the storage devices 1006, 1008 communicate through one conductive cable 1024, asynchronicity of testing may be maintained with respect to temperature control, communications, and voltage control, as the storage devices 1006, 1008 may maintain independent communication with the test slot circuitry view the interposer 1022.

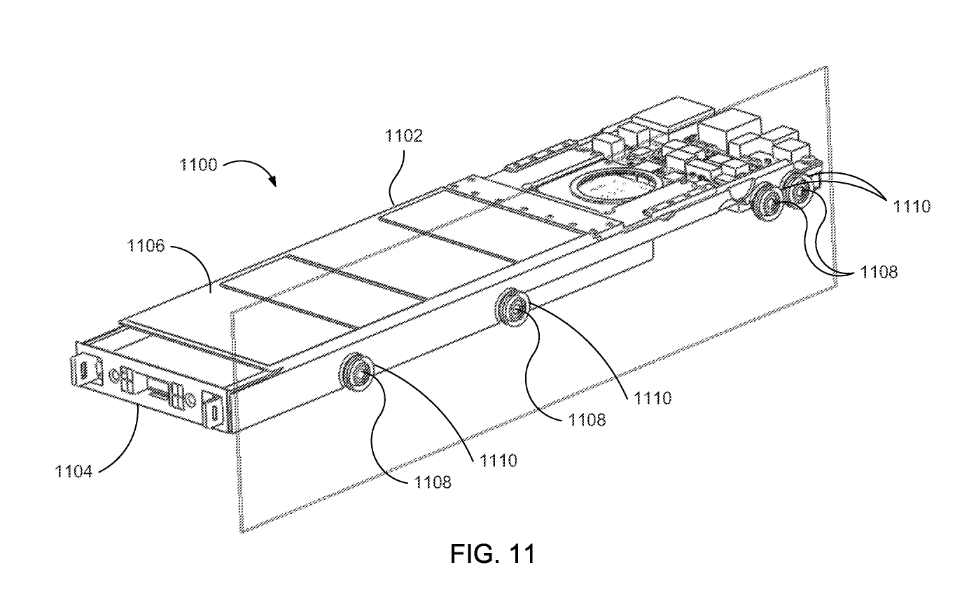

In some examples, arranging and storing storage devices 1006, 1008 in the dual storage device transporter 1000 can increase the total Y dimension of a typical storage device transporter to be extended by the length of a storage device 1008 plus the Y dimension of the interposer 1022. However, if the storage device 1008 is, for example, a standard dimension 2.5″ hard disk drive, then the total added length added to a typical storage device transporter would be approximately 130 mm. If this Y dimension increase is applied to the exemplary system of FIG. 1, which has a diameter of approximately 3350 mm, it can be calculated that by using the dual storage device transporter 1000 (e.g., in combination with a dual storage device test slot 1100 (FIG. 11)), the number of hard disk drives in the resulting system may be doubled, with a footprint increase of only approximately 16%.

FIG. 10D shows a dual storage device transporter 1000D which includes many of the same features as the dual storage device transporter 1000. For example, the dual storage device transporter 1000D includes supportive heating elements 1016D, automation engagement features, supportive heating elements 1016D, electrical connectors 1014D, and a common connector 1026D which are similar to those elements described above with regard to the dual storage device transporter 1000. Dual storage device transporter 1000D also includes two cavities 1004D, 1006D each configured to support (e.g., by clamping) a storage device 1002D, 1004D, respectively. Dual storage device transporter 100D includes a first interposers 1022D and a second interposer 1023D which engage with the storage device connectors 1018D, 1020D, respectively, so as to allow the storage devices 1002D, 1004D to maintain the same orientation relative to storage device transporter 1000D (e.g., the storage device connectors 1018D, 1020D both face the common connector 1026D). As shown in FIG. 10E (which illustrates a cutaway view FIG. 10D) the two interposers 1022D and 1023D are connected via a conductive cable or flex circuit 1024E to the common connector 1026D. Arranging the storage devices 1002D, 1004D in a common orientation may provide allow simplify one or more of automatic manipulation of the storage devices 1002D, 1004D, vibration control, or bar code reading (described in greater detail below).

FIG. 11 shows an arrangement 1100 that includes a test slot 1102 (e.g., a rigid storage device test slot) supporting a dual storage device transporter 1104. The test slot 1102 includes a housing 1106 the forms the body of the test slot, an also includes isolator engagement features 1108 that secure the housing 1106 of the test slot 1102 to a surface of supporting unit, such as the chassis 102 of the test rack 100 (FIG. 2). The arrangement 1100 also includes isolators 111 disposed between respective isolator engagement features 1108 and the rack or subassembly. In some examples, the isolators 1365 can dampen, absorb, attenuate, or otherwise reduce vibration transfer associated with the dual storage device test slot 1102.

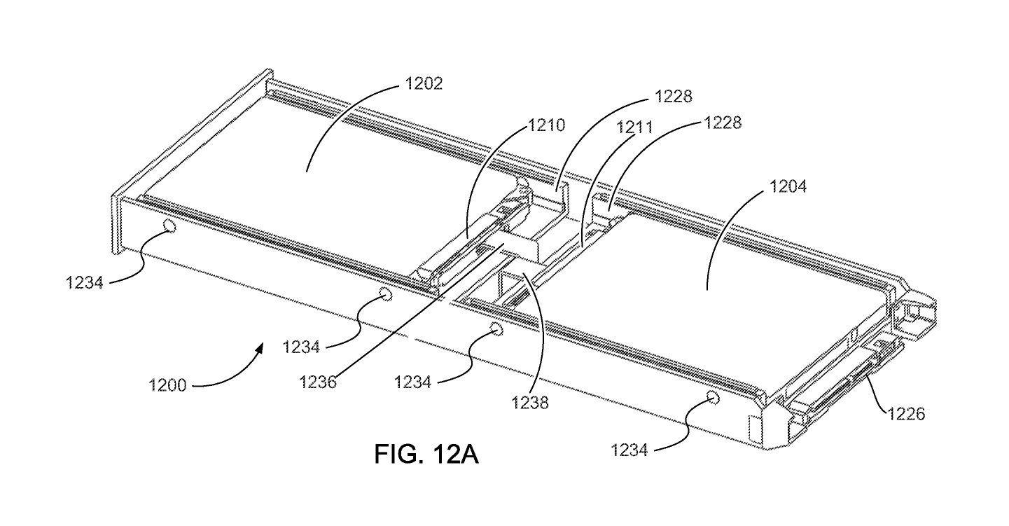

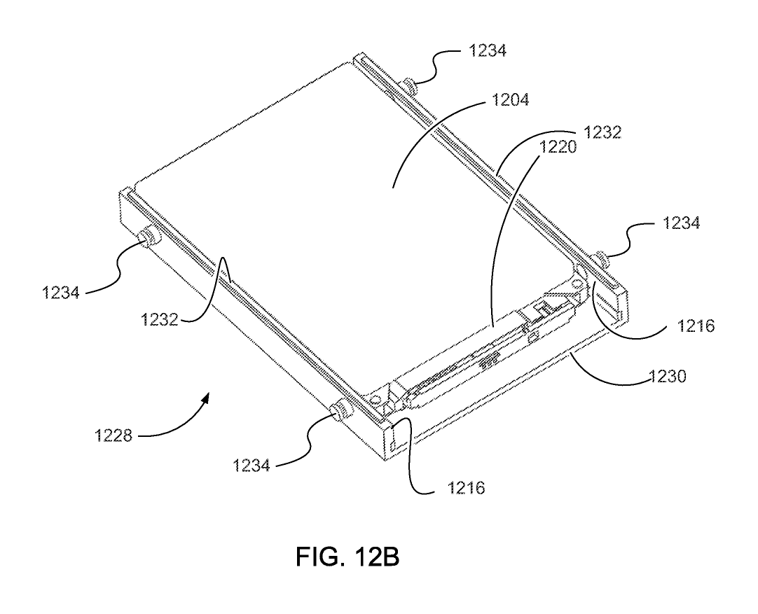

FIGS. 12A and 12B illustrate an example of a dual storage device transporter 1200 and a portion thereof (e.g., a clamping nest), respectively. In this example, the dual storage device transporter 1200 incorporates a clamping nest 1228 for each storage device 1202, 1204 supported by the dual storage device transporter 1200. In some examples, the clamping nest 1228 is a rigid assembly that includes at least one clamping assembly (e.g., supportive heating elements 1216) and a rigid housing 1230. The supportive heating elements 1216 are engaged by the activation of (e.g., by depressing) a wedge 1232 after some or all of a storage device 1204 has been positioned within the clamping nest 1228. In some examples, each clamping nest housing 1230 is attached to, and isolated from, a frame of the storage device transporter 1200 by means of at least one isolator 1234, which is disposed between the clamping nest housing 196 and the frame of the storage device transporter 190.

In some examples, the isolators 1234 may attenuate vibration transfer between the rigid combination of a clamped storage device 1202, 1204 and the clamping nest 1228 to other portions of the storage device test system (e.g., to other storage devices under test, other test slots, other packs (e.g., a group of two or more transporters that can be transported as a single unit), and other racks). In order to test the storage devices 1202, 1204, the dual storage device transporter 1200 can be disposed within a storage device test slot (e.g., the test slot 1102 (FIG. 11)) configured to support (e.g., rigidly support) the dual storage device transporter 1200. In this manner, each storage device 1202, 1204 can be vibrationally isolated from other storage devices and from a storage device test rack. The arrangement of the dual storage device transporter 1200 and its features shown in FIGS. 12A and 12B retain the asynchronous test advantages of the examples shown in FIGS. 10A-10E. Furthermore, by providing a clamping nest 1228 for each storage device within the dual storage device transporter 1200, the arrangement of the dual storage device transporter 1200 and its features shown in FIGS. 12A and 12B also provide separate vibration isolation for each storage device 1202, 1204. The dual storage device transporter 1200 also includes a first interposer 1210 and a second interposer 1211. The first interposer 1210 and the second interposer are each connected a respective flexible cable 1236, 1238, which may, in turn, be connected to a common connector 1226 via a third interposer. This arrangement allows the separate vibration isolation to be preserved, as the storage devices and clamping nests are vibrationally isolated by the flexible cables 1236, 1238 (e.g., rigid connections between the two clamping nests and storages devices are reduced).

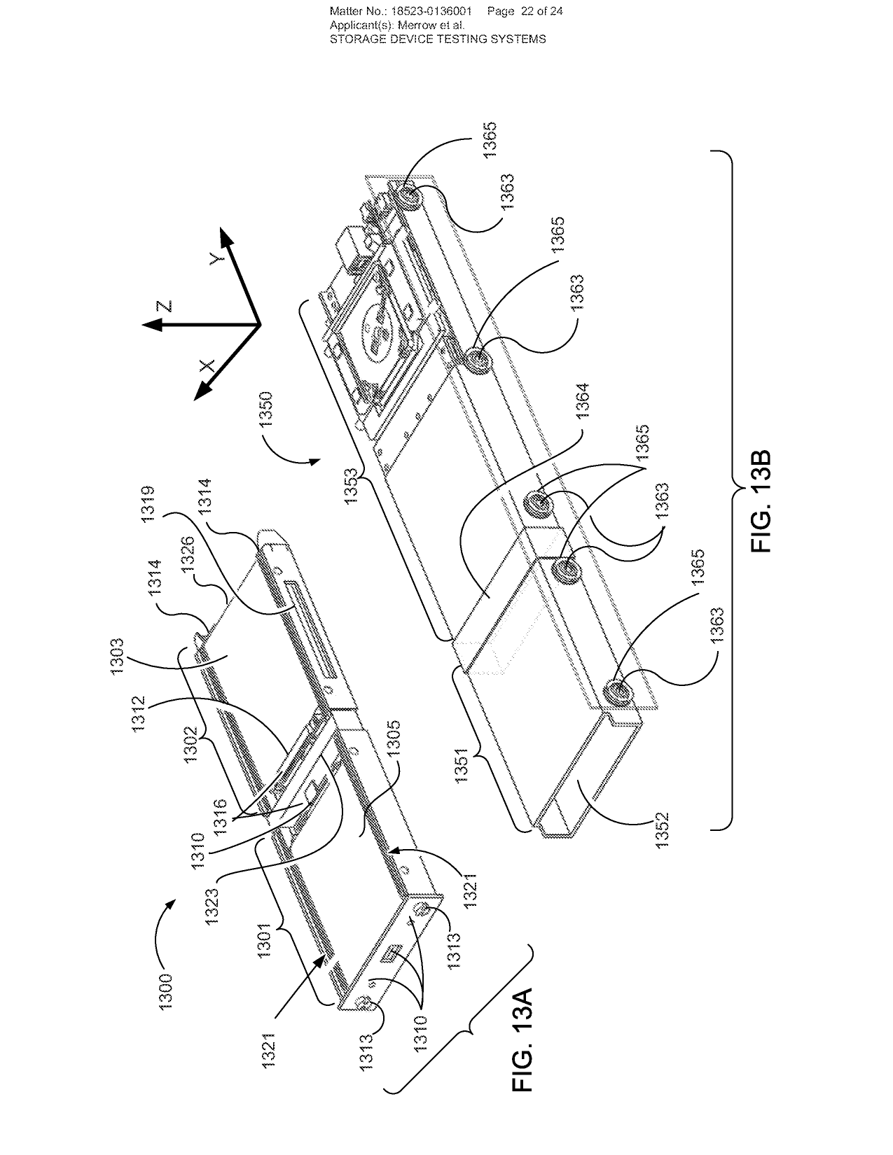

FIGS. 13A and 13B show a dual storage device transporter 1300 that includes both a front portion 1301 and a rear portion 1302, and a storage device test slot 1350. The front portion 1301 and the rear portion 1302 are each configured to support one storage device (e.g., the storage device 1303 within the rear portion 1302) white being transported inside of a storage device test system, and also during testing (e.g., when the dual storage device transporter 1300 is supported by storage device test slot 1350). In some examples, the dual storage device transporter 1300 includes features that correspond to similar features of the dual storage device transporter 1000 (e.g., automation engagement features 1310, electrical connectors 1314, and common connector 1326). The storage devices 1303, 1305 each include a respective connector 1310, 1312 that can be arranged into electrical communication with the common connector 1326. In some examples, the dual storage device transporter 1300 includes two interposers 1316 which are each configured to mate with a corresponding one of the storage device connectors 1310, 1312. A connection between each of the two interposers 1316 and the common connector 1326 can be established through a conductive cable or flex circuit, as described above.

Dual storage device transporter 1300 also includes clamp actuators 1313, which includes clamp actuators 1012, which are arranged to engage (e.g., to mate or connect with) corresponding clamp engagement elements 904B on the manipulator 900B, and also includes clamps 1321. In some examples, the clamps 1321, when engaged by the clamp actuators 1313, hold the storage device 1305 or, when the storage device 1305 and storage device transporter 1300 are placed inside of the cavity 1352 of the dual storage device test slot 1350, hold the storage device 1305 substantially motionless relative to the housing of the dual storage device test slot 1350. The rear half 1302 of dual storage device transporter 1300 comprises a slot 1319 in each of two sidewalls of the dual storage device transporter 1300. The slots 1319 may allow, for example, a progressive clamp associated with the dual storage device test slot 1350 to progressively engage the storage device 1303 as the storage device transporter 1300 is inserted into cavity 1352 of the dual storage device test slot 1350. Consequently, when the dual storage device transporter 1300 is fully inserted into cavity 1352, the progressive clamp may hold the storage device 1303 substantially motionless relative to a housing of the dual storage device test slot 1350. In some examples, the storage device 1305 may be clamped by the end effector clamp activation features 904B actuating the clamp actuators 1313.

In some examples, the front half 1301 and rear half 1302 are joined by a resilient material 1323. The resilient material 1323 may be sufficiently rigid to allow the two portions to maintain their relative X and Z positions, and to permit the front portion 1301 and the rear portion 1302 to be inserted and removed as a unit from dual storage device test slot 1350, but are sufficiently flexible to attenuate vibration transmission between the two portions. In some examples, the resilient material 1323 may be composed of thermoplastics, elastomers, thermosets, natural rubber, or other materials or assemblies with vibration isolation and/or dampening characteristics.

The dual storage device test slot 1350 comprises a front portion 1351 and a rear portion 1353. In some examples the cavity 1352 runs the length of the two portions, which may also be joined by a resilient material 1364. The resilient material 1364 may be similar to the resilient material 1323 in composition and purpose. In some examples each portion 1351 and 1353 can be separately isolated from a test rack and other parts of a testing environment by isolator engagement features 1363 and isolators 1365. The isolators 111 are configured to attenuate vibration transfer between the two assemblies to which they are attached.

In some examples, when the dual storage device transporter 1300 is inserted into cavity 1352 of dual storage device test slot 1350, and the clamps 1321 and the progressive clamps are engaged, the storage devices 1303, 1305 in dual storage device transporter 1300 can be rigidly clamped to their respective portions of the dual storage device transporter 1300 and to their respective portions of the dual storage device test slot 1350. Since each portion is separately isolated, vibration transmission between the storage devices 1303, 1305 and between each storage device 1303, 1305 and the rest of the storage device test system can be attenuated.

In some examples, the dual storage device transporter 1300 may include clamps in both portions 1301, 1302 of the storage device transporter 1300. The clamps in both portions 1301, 1302 can be actuated by common actuators 1313, which are configured to engage a connection between the clamps in the respective front and rear portions 1301 and 1302, allowing the clamps to be engaged and the connection between the front and rear halves 1301 and 1302 to subsequently be disconnected, so as to remove a possible path for vibration coupling between the front and rear portions 1301 and 1302. In such an arrangement, the resilient material 1323 may be omitted entirely, allowing the disconnectable mechanical linkage that connects the clamps in the front and rear halves to serve as the only connection between the two halves.

In some examples, the dual storage device transporter 1300 may include slots 1319 in both portions 1301 and 1302. Progressive clamps can be provided in the housing of the dual storage device test slot 1350, so that both portions 1301 and 1302 can be separately clamped to their respective portions of the dual storage device test slot 1350.

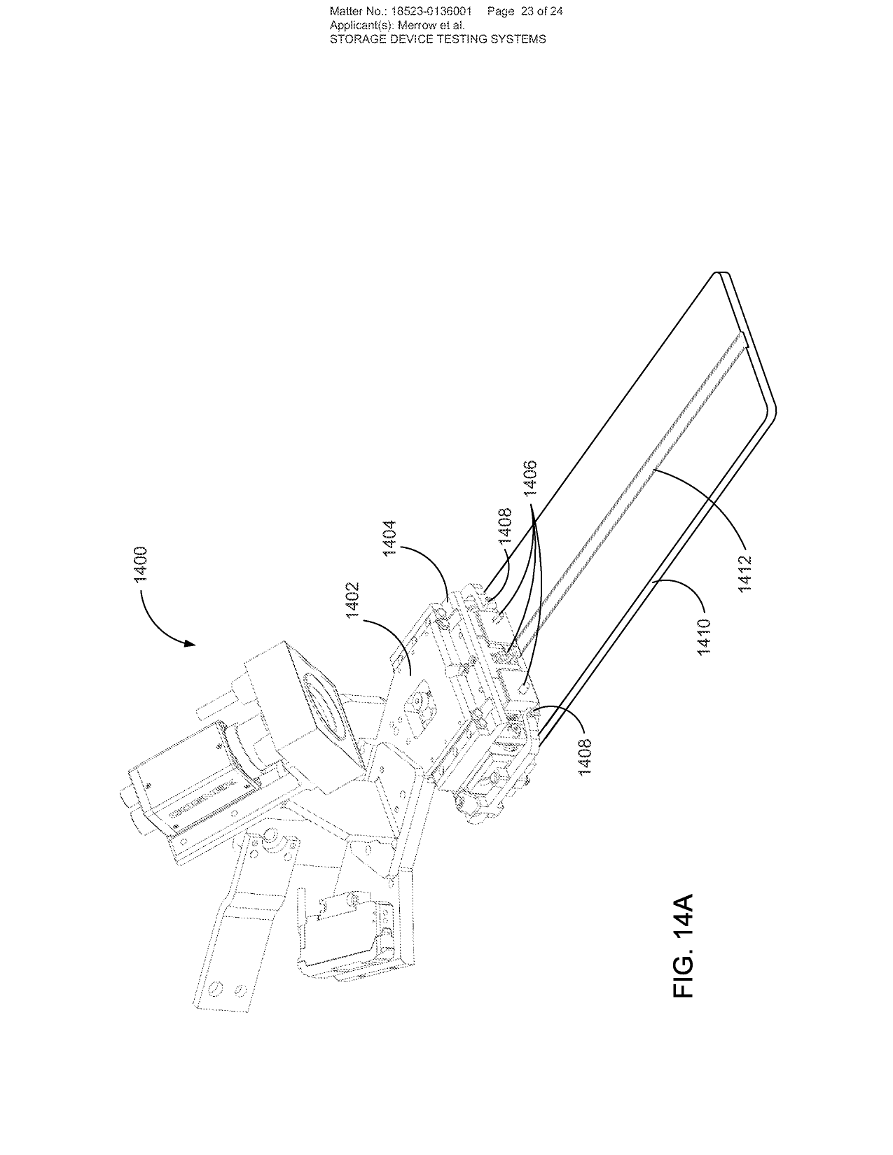

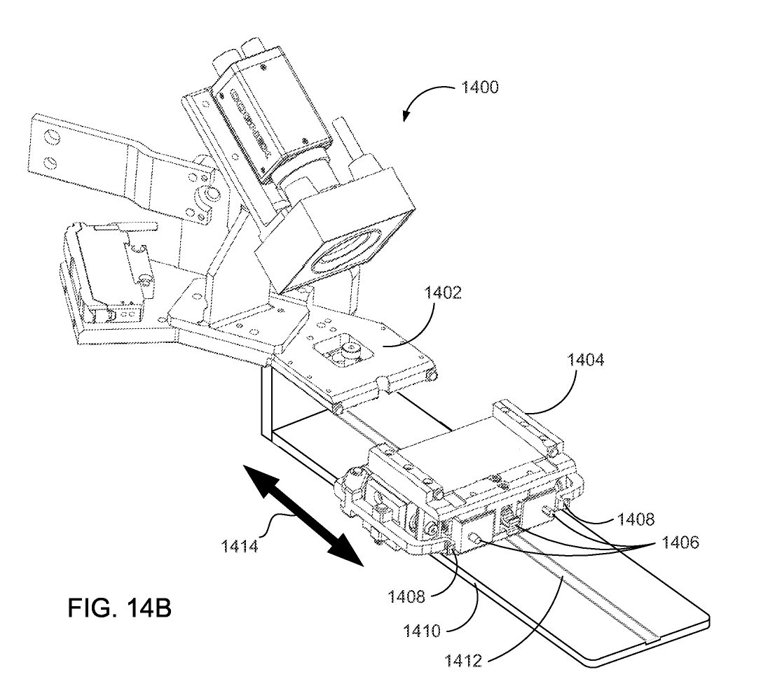

FIGS. 14A and 14B show an end effector 1400 that includes two sections: a fixed section 1402 and a movable section 1404. The moveable section 1404 includes transporter engagement features 711 which, when engaged with automation engagement features of the dual storage device transporters discussed herein, allow the end effector 1400 to grasp and align itself with a dual storage device transporter (e.g., the dual storage device transporter 1000). The moveable section 1404 also includes clamp activation features 1408. The clamp activation features 1408, when engaged with clamp actuators of the dual storage device transporters discussed herein, enable the moveable section 1404 to clamp and unclamp clamp actuators (e.g., the clamp actuators 1012). In some examples, the fixed section 1402 is rigidly attached to the end of an automated transporter. The fixed section 1402 includes a horizontal roadway 1410, which in turn comprises track 725. In some examples, the horizontal roadway 1410 is configured to support storage device transporter or a dual storage device transporter white the transporter is moved inside a storage device test system. The moveable section 1404 can be configured to travel along the track 1412, as shown in FIG. 14B by the directional arrow 1414. In some examples, the combination of the roadway 1410, the track 1412, and the moveable section 1404 can be used to insert and remove dual storage device transporters (e.g., the dual storage device transporter 1000) to and from test slots. In some examples, the end effector 1400 can be used to insert a dual storage device transporter carrying two storage devices into a test slot substantially simultaneously.

In some examples, the moveable section 1404 may not, in fact, be moveable, but may instead remain stationary relative to the fixed section 1402. In such an example, insertion and removal of a dual storage device transporter with respect to a dual storage device test slot may be accomplished by causing the horizontal roadway 1410 to be inserted into a gap between adjacent dual storage device test slots.

A number of implementations have been described. Nevertheless, it will be understood that various modifications may be made without departing from the spirit and scope of the disclosure. For example, in some implementations, more than two storage devices may be supported in the same plane. For example, the dual storage device transporters discussed herein could be extended to accept three or more storage devices aligned along the same Y axis. Alternatively, the dual storage device transporters discussed herein could be extended to support two or more storage devices substantially aligned next to each other along the X axis. Alternatively, the dual storage device transporters discussed herein could be extended to support four or more storage devices (e.g., arranged in a grid formation) aligned along both the X and Y axes. In the case of a grid formation, corresponding end effectors could also be extended along the X axis to accommodate multiple dual storage device transporters.

In some examples, the storage device test slot may be oriented so that their x-y plane is oriented in the y-z plane of FIG. 3B.

In some implementations, the clamping of a storage device can be associated with a slot housing, rather than the storage device transporter. For example, when a storage device transporter is used, the storage device transporter could have a slot in opposing sidewalls, through which a clamp can extend to clamp the storage device to the slot housing. In such an implementation, the clamping may be actuated by an actuator associated with the slot housing, or by a progressive clamp associated with the slot housing.

In some implementations, storage devices may be placed in a storage device transporter so that, when inserted into a storage device test slot, the longest axis of the storage devices is oriented at right angles to the longest axis of the storage device test slot.

In some implementations, the end effector may grip or support multiple storage devices directly, without the use of a storage device transporter. In such implementations, the end effector may place multiple storage devices directly in to the storage device test slot, which is configured to accommodate multiple storage devices. A roadway 720 may also be used to support the storage devices during insertion and removal, or the clamping of the storage device during transport may be effected without the use of a roadway. If storage device clamping within the storage device test slot is used in this implementation, the clamping is associated with the storage device test slot housing, rather than the storage device transporter.

In implementations where vibration is less of a concern, for example when the storage device is a Solid State Drive SSD), the clamping and/or isolation may be omitted entirely.

In some implementations, the storage device transporter is moved and manipulated manually by an operator, rather than by an end effector.

In some implementations, the end effector, storage device transporter, and/or storage device test slot comprise additional features to actuate a Y-axis motion of one or more storage devices, so as to effect a connection between the storage device connector and a mating connector. This actuation may occur while the storage device is being transported in the storage device transporter, or while the storage device is supported in a storage device test slot.

In some implementations, the mating of one or more storage device connectors to a mating connector can be effected by the motion of inserting the storage device into the storage device test slot.

In some implementations, the mating of one or more storage device connectors to a mating connector is effected by a human operator.

What is claimed is:

1. A storage device test system comprising:
a test slot configured to receive at least two storage devices for testing, the at least two storage devices being in a same plane.

2. The storage device test system of claim 1, wherein the same plane comprises a first same plane, and wherein the storage device test system further comprises:
a rack for holding the test slot and additional test slots, with at least one of the additional test slots configured to receive at least an additional two storage devices in a second same plane for testing.

3. The storage device test system of claim 1, wherein the test slot has a longitudinal dimension, and wherein the same plane is along the longitudinal dimension.

4. The storage device test system of claim 1, further comprising:
a storage device transporter configured to hold the at least two storage devices in the same plane, with the test slot being configured to receive the storage device transporter.

5. The storage device test system of claim 4, where the storage device transporter comprises engagement features for holding the at least two storage devices in the storage device transporter.

6. The storage device test system of claim 4, wherein each of the at least two storage devices is held in a different area of the storage device transporter; and
wherein an area of the storage device transporter comprising a heating element for adjusting a temperature of a storage device located in the area.

7. The storage device test system of claim 4, wherein the storage device transporter comprises support structures;
wherein a support structure comprises an isolator;
wherein the isolator is located on the storage device transporter at a location that corresponds to a location of a storage device receptacle; and
wherein the isolator is for attenuating at least sonic vibrations associated with a storage device in the storage device test system.

8. The storage device test system of claim 7, wherein the isolator comprises a first isolator, the storage device comprises a first storage device, and wherein the storage device test system further comprises:
a second isolator that is configured to attenuate at least some vibrations of a second storage device substantially separately from attenuation by the first isolator of vibrations of the first storage device.

9. The storage device test system of claim 1, wherein the test slot is configured to receive more than two storage devices for testing.

10. The storage device test system of claim 4, wherein the storage device transporter comprises:
an interposer between two adjacent areas for holding storage devices in the storage device transporter, the interposer comprising connectors for interfacing to mating connectors of storage devices;
a transporter connector for interfacing to a mating connector of the test slot; and
an electrical path between the interposer and the transporter connector.

11. The storage device test system of claim 10, wherein the interposer comprises a first interposer, the electrical path comprises a first electrical path, and wherein the storage device transporter further comprises:
a second interposer, the second interposer being adjacent to an area for holding a storage device and adjacent to the transporter connector, the second interposer comprising a connector for mating to a corresponding connector of the storage device; and
a second electrical path between the second interposer and the transporter connector.

12. The storage device test system of claim 11, wherein the first interposer and the second interposer are configured to maintain storage devices in the storage device transporter to be at a same orientation relative to the test slot.

13. The storage device test system of claim 2, wherein the rack is configured to hold the test slots in an orientation that is substantially parallel to a surface supporting the storage device test system.

14. The storage device test system of claim 2, wherein the rack is configured to hold the test slots in an orientation that is substantially perpendicular to a surface supporting the storage device test system.

15. The storage device testing system of claim 1, further comprising:
at least one automated transporter;
multiple racks arranged relative to the at least one automated transporter for servicing by the at least one automated transporter; and
multiple test slots housed by each rack, each test slot being configured to receive a storage device transporter configured to carry multiple storage devices for testing, each of the multiple storage devices being in a same plane.

16. The storage device testing system of claim 15, wherein the at least one automated transporter comprises a manipulator configured to engage the storage device transporter of one of the test slots, the automated transporter being operable to carry the storage device transporter to the test slot for testing of the multiple storage devices.

17. The storage device testing system of claim 1, further comprising:
a temperature control system configured to control a temperature of the test slot.

18. A storage device transporter for transporting a storage device and for mounting the storage device within a test slot, the storage device transporter comprising:
a frame configured to receive multiple storage devices in a same plane, the frame comprising areas configured to receive the multiple storage devices, the frame being sized to be inserted into the test slot while holding the multiple storage devices.

19. The storage device transporter of claim 18, further comprising:
a clamping mechanism comprising:
an engagement element; and
an actuator operable to initiate movements of the engagement element,
wherein the actuator is operable to move the engagement element into engagement with the test slot.

20. The storage device transporter of claim 18, wherein each of the multiple storage devices is held in a different area of the storage device transporter;
wherein an area of the storage device transporter comprises a heating element for adjusting a temperature of a storage device in the area.

21. The storage device transporter of claim 18, further comprising support structures;
wherein a support structure comprises an isolator that is located on the storage device transporter at a location that corresponds to a location of a storage device receptacle; and
wherein the isolator is for attenuating at least some vibrations associated a storage device in the storage device transporter.

22. The storage device transporter of claim 21, wherein the isolator comprises a first isolator, the storage device comprises a first storage device, and wherein the storage device transporter further comprises:
a second isolator that is configured to attenuate at least some vibrations of a second storage device, in the storage device transporter, substantially separately from attenuation by the first isolator of vibrations of the first storage device in the storage device transporter.

23. The storage device transporter of claim 18, further comprising:
an interposer between areas for holding storage devices in the storage device transporter, the interposer comprising connectors for interfacing to mating connectors of storage devices;
a transporter connector for interfacing to a mating connector of the test slot; and
an electrical path between the interposer and the transporter connector.

24. The storage device transporter of claim 23, wherein the interposer comprises a first interposer, the electrical path comprises a first electrical path, and wherein the storage device transporter further comprises:
a second interposer, the second interposer being adjacent to an area for holding a storage device and adjacent to the transporter connector, the second interposer comprising a connector for mating to a corresponding connector of the storage device; and
a second electrical path between the second interposer and the transporter connector.

25. The storage device transporter of claim 24, wherein the first interposer and the second interposer are configured to maintain storage devices in the storage device transporter to be at a same orientation relative to the test slot.

26. The storage device transporter of claim 18, wherein the frame comprises sections; and
wherein one of the sections is connected to another one of the sections by a material that is more flexible than a material making-up the sections.

27. The storage device transporter of claim 26, wherein the material that connects the sections comprises a resilient material.

28. The storage device transporter of claim 18, wherein a first one of the to multiple storage devices is associated with a first identifier and a second one of the multiple storage devices is associated with a second identifier; and
wherein the first and second of the at least two storage devices are positioned in the test slot such that one of the first and second identifiers is visible from outside the test slot.

29. A method performed by a storage device test system, comprising:
receiving at least two storage devices in a test slot, the at least two storage devices being in a same plane in the test slot.

30. The method of claim 29, wherein the same plane comprises a first same plane, and wherein the method further comprises:
holding the test slot and additional test slots in a rack of the storage device test system, with an additional test slot being configured to receive at least two additional storage devices in a second same plane for testing.

31. The method of claim 29, wherein the test slot has a longitudinal dimension, the same plane being along the longitudinal dimension.

32. The method of claim 29, further comprising:
holding the at least two storage devices in the same plane in a storage device transporter in the test slot, with the test slot being configured to receive the storage device transporter.

33. The method of claim 32, further comprising:
holding, by engagement features of the storage device transporter, the at least two storage devices.

34. The method of claim 29, further comprising:
moving, to the test slot, a storage device transporter carrying multiple storage devices for testing in the same plane.

35. A method comprising:
receiving, in a storage device transporter, at least two storage devices for insertion into a test slot, the at least two storage devices being in a same plane;
transporting, by the storage device transporter, the at least two storage devices to the test slot; and
inserting, by the storage device transporter, the at least two storage devices within the test slot, wherein the at least two storage devices are maintained in the same plane following insertion into the test slot.

36. The method of claim 35, further comprising:
attenuating at least some vibrations of a first storage device substantially separately from attenuating vibrations of a second storage device.
